(19) United States
(12) Patent Application Publication
(10) Pub. No.: US 2010/0087144 A1
(43) Pub. Date: Apr. 8, 2010

(54) Short Range Exchange of Information

(76) Inventor: Roni Korenshtein, Tel Aviv (IL)

Correspondence Address: IBM CORPORATION, T.J. WATSON RESEARCH CENTER, P.O. BOX 218, YORKTOWN HEIGHTS, NY, 10598, US

(21) Appl. No.: 12/243,981

(22) Filed: Oct. 2, 2008

(51) Int. Cl. H04B 7/00

(52) U.S. Cl. 455/41.2

(57) ABSTRACT

A method for exchanging short range information, the method includes: receiving, by a first device and over a short range communication channel, a strength indication signal that is transmitted from a second device; wherein the strength indication signal is representative of a strength of a signal that was transmitted by the third device and was received by the second device; estimating locations of the second device and the third device in response to a content of the strength indication signal and in response to a strength of a signal that is received by the first device and was transmitted by the second device; and providing to a user of the first device location information representative of the locations of the second device and of the third device.

### FIELD OF THE INVENTION

The present invention relates to devices, methods and computer program products for short range exchange of information and especially for exchanging information by using the Bluetooth protocol.

### BACKGROUND OF THE INVENTION

It is sometimes desired to call or send a message to a device near-by, when the device is indoor or outdoor, and the device is either in view or its relative position may be known (e.g. it's in the room to my left). This requires to know in advance the identifier of the other device (such as phone number if a call or a transmission of an SMS message is desired, or a Bluetooth identifier if Bluetooth communication is required).

Communicating with devices based upon their Bluetooth ID or to names assigned by the device owners can be very problematic. This problem usually arises when a device of a user receives signals from multiple devices and the user can not distinguish between the devices. The lack of distinctiveness can be contributed to the problematic format of the Bluetooth ID which is an arbitrary combination of letters and numbers (for example—“128737439839FEA23). Users can assign their own devices with a nickname that is not very informative (such as “my phone”). Another user that tries to contact such a device can be presented with meaningful device identifiers or nicknames.

There is a growing need for an efficient and simple communication between devices.

### SUMMARY OF THE INVENTION

A method for exchanging short range information, the method includes receiving, by a first device and over a short range communication channel, a strength indication signal that is transmitted from a second device; wherein the strength indication signal is representative of a strength of a signal that was transmitted by the third device and was received by the second device; estimating locations of the second device and the third device in response to a content of the strength indication signal and in response to a strength of a signal that is received by the first device and was transmitted by the second device; and providing to a user of the first device location information representative of the locations of the second device and of the third device.

The method can include providing a map that comprises a second symbol that represent an estimated location of the second device and a third symbol that represents an estimated location of the third device; wherein the map is rotatable along its axis.

The method can include providing a map that comprises a second symbol that represent an estimated location of the second device, an third symbol that represents an estimated location of the third device, a second device identifier and a third device identifier; wherein the second device identifier and the third device identifier are defined by the user of the first device.

The method can include providing a map that comprises multiple third symbols that represent possible locations of the third device.

The method can include receiving from a user of the first device a request to communicate with the second device via a non-short range communication channel; and initiating a communication via the other communication channel.

The method can include initiating the communication via the other communication channel by sending a communication controller a short range communication identifier of the second device.

### BRIEF DESCRIPTION OF THE DRAWINGS

The present invention will be understood and appreciated more fully from the following detailed description taken in conjunction with the drawings in which:

FIG. 1 illustrates a method for exchanging short range information, according to an embodiment of the invention;

FIG. 2 illustrates a method for exchanging short range information, according to an embodiment of the invention;

FIG. 3 illustrates a mobile device, according to an embodiment of the invention; and

FIGS. 4A through 4L illustrate a display of the first device, according to an embodiment of the invention.

### DETAILED DESCRIPTION OF THE DRAWINGS

A method, a system, and a computer program product are provided. They facilitate short range exchange of information between devices and even short and medium range (indirect) exchange of information between devices that are proximate to each other.

According to suggested embodiments of the invention a user is provided with information indicative of locations of other devices. Various embodiments of the invention are not dependent upon Global Positioning System (GPS) technology and can work indoors, and do not require a centralized communication network or an electronic compass in order to exchange information.

According to various embodiments of the invention a user is provided with information indicative of locations of other devices that are out of sight but are relatively close to the user.

According to various embodiments of the invention a user can assign device identifiers (aliases) to each device. The device identifiers can be user friendly and can include few or multiple textual symbols. The aliases can be maintained in a data structure that maps between device identifiers (aliases) assigned by other entities (such as the manufacturer of a device, a user of another device and the like).

According to an embodiment of the invention a device can communicate with other device without being aware of the exact (absolute) location of each device.

Conveniently, a user is presented with map that includes multiple symbols, each of which represents an estimated location of another device, wherein the map is conveniently rotatable along its axis

According to an embodiment of the invention a user is presented with the orientation of nearby electronic devices, relative to a user device (which is conveniently referred to as the first device). Thus, actions such as capturing Bluetooth ID's of other device is facilitated, and communicating with a device selected by the user from the display of the first device, without having any prior knowledge of any of the devices' ID's is enabled.

Conveniently, communication between the first device and another nearby device is enabled by performing the following stages:
a. collecting relative distances of multiple devices;
b. displaying estimated locations of at least some of the multiple devices on a display of the first device;
c. providing to the user the means to orient the display to match physical orientation, and orienting (usually rotating) the display according to user orientation inputs.
d. receiving from the user device selection indication, indicating a selected device out of the multiple devices represented on the display of the first device; and
e. performing a user selected action on the selected device (such as communicating with the selected device, assigning a device identifier for the selected device, etc.)

According to an embodiment of the invention, the assigning of the device identifier for the selected device is supported by capturing and maintaining a device identifiers database of association between personas or entities known to the user (e.g. names, descriptions, functionalities) and device identification information of devices associated with said personas or entities (e.g. Bluetooth information).

The capturing and maintaining of the device identifiers database is carried out, according to an embodiment of the invention, in the following manner.

Once the user has selected the device on the display (ab hinc also referred to as screen), the user may select the “capture device identifier” (e.g. “capture Bluetooth information”) action.

In response, the first device prompts the user to enter a device identifier (alias) for that device. the user may enter a nick name for that persona or entity such as the name of the person holding the device or something like “The person with whom I talked in the park”. Alternatively, according to an embodiment of the invention, the user may select a contact from a contact list of the first device, associating the selected device with a contact person already on the list.

According to an embodiment of the invention, the user may be also be prompted to enter a comment or any other information related to that persona.

The information entered by the user as well as the Bluetooth ID and Bluetooth friendly name (or other device identification information, such as device identifiers allocated by other entities, e.g. if using communication means other than Bluetooth) are then saved in the device identifiers database.

From this point, whenever that device (i.e. the device to which a device identifier was assigned) is detected and shown on the display the first device, the first device initially search the device identifiers database to determine if the entry is found, so that the device identifier and/or other information may be presented instead of, or in addition to, the Bluetooth ID or friendly name (or other device identification information) that are displayed for a detected device presented on the screen.

The device identifiers database conveniently can also provide an interface for other applications that present to the user Bluetooth ID's friendly name (or other device identification information) of detected devices. Said interface allows these applications to present the user with a device identifier given by the user to another device, as opposed to a meaningless Bluetooth ID or a friendly name (or other device identification information) which is given to the device by its owner, manufacturer or other identify, and may change at any time. Thus, conveniently, whenever an application needs to present the user with a list of detected devices it can first initiate a lookup at the device identifiers database for each detected device identification information and see if it has an entry in the device identifiers database; if a matching entry is found the application can display the user-given device identifier obtained from the device identifier database, and if no matching entry is found, to display the detected device identification information. Conveniently, means are also provided to the user for edit entries, delete entries, and additional database management actions.

### Device Collecting Relative Distances

The first device (as a querying device) is adapted to initiate an inquiry (e.g. a Bluetooth inquiry) for detecting other devices (e.g. Bluetooth devices) within its range, following which the first device obtains an indication of the signal strength between it and each detected device.

The first device then conveniently creates a list of pairs, wherein each pair contains the device identification information (ab hinc also referred to as device ID) discovered, and the associated signal strength between that device and the first device.

The first device then modifies the associated signal strength in each of the above pairs with a calculated “relative distance”, by a conversion that is described below but its essence is that the closer two devices are to each other, the stronger is the signal between them.

The first device is further adapted to send a request for signal strengths to one or more devices of the multiple detected devices, wherein the request for signal strength conveniently includes a “list of detected devices ID's” that was prepared by the device, wherein the list of detected devices ID's conveniently includes the device identification information (such as Bluetooth ID) of all the devices detected by the first device, but may also include only some devices of the detected device. Conveniently, requests for signal strength are sent to all the devices included in the list of detected devices ID's.

The first device then receives, from at least one device to which a request for signal strength was sent (referred to as a second device), over a short range communication channel, a strength indication signal, wherein the strength indication signal is representative of a strength of a signal that was transmitted by another device (referred to as a third device, i.e. that is different from the first device and from the second device) and was received by the second device. Conveniently, any such second device (also referred to as a servicing device) transmits to the first device strength indication signals representative of the strength of the respective signals transmitted to the second device from each of a group of devices that are detected both by the second device and by the first device (referred to as detected devices intersection list).

Each of the devices that receive requests for signal strength and which service such a request (naturally, some devices may not respond; a device that responds is referred below as a servicing device), responds after executing the following actions:
a. determining a “servicing device set of detected devices”, including the devices detectable by the servicing device (i.e. the device identification information thereof);
b. calculating a “detected devices intersection list” that is the intersection of the list of detected devices ID's received from the first device and of the servicing device set of detected devices of the servicing device.
c. obtaining, for one or more devices of the detected devices intersection list (and conveniently to all of them), the signal strength between the servicing device and each of the one or more devices.
d. transmitting to the first device a “set or pairs”, each pair contains a device ID of a device from the detected devices intersection list and an associated signal strength between that device and the servicing device.

Upon receiving a response from a certain servicing device, the first device conveniently operates on each of the pairs in the returned “set or pairs”, modifying the signal strength in each pair with a calculated “relative distance” (converted from signal strength) and stores the new “set or pairs” in association with the servicing device ID. (wherein, as aforementioned, this may be carried out for a single second device, or usually for multiple servicing devices).

Alternatively, the second device may, according to an embodiment of the invention, convert on its own from the signal strength (between the second and a third device) to “relative distance”, and so to return pairs which already contain the “relative distance”, so the first device does not have to do this conversion. This may be important if the servicing device may have to later on respond to the same type of request from other querying devices, in which case it may cache the pairs for some period of time, and respond to querying devices with the cached pairs.

According to an embodiment of the invention, the first device receives from the second device a triplets (or set of triplets, instead of set of pairs), where each triplet contains the above pair of information, along with device identification information of the servicing device (even though the first device may also convert each received pair to a triplet by adding the device identification information of the servicing device from which the pair was received).

According to an embodiment of the invention, a servicing device may record the request received from the first device and immediately return. Then it may invoke a service of the first device several times by sending either a pair or a triplet in each request, and finally sending and end-indication after all pairs or triplets have been sent. This way the first device may receive pairs or triplets from various servicing devices as they become available on each servicing device (this facilitates a parallel like receiving of such information, as opposed to a sequential process described above). The first device, according to such an embodiment of the invention, is conveniently adapted to keep track of which servicing device has not yet sent its “end-indication”.

Referring generally to the participating device, the devices are conveniently at least partly interchangeable by that the first device may operate as a second device for another device, and as a third device for yet another device. Conveniently, devices that are capable of operating as the first device are also capable of operating as second devices, and vice versa. It is noted that the third devices are not necessarily capable of operating as first or second devices, even though it is perfectly implementable.

Both the first device and at least one second device are, as aforementioned, adapted to convert strength of signal to relative distance; such a conversion, according to an embodiment of the invention, is now explained.

A signal strength is converted to a “relative distance”, so that a number between 0 and 1 (or within parallel range) is provided instead of the signal strength, in the above algorithm, as follows:

If for example the relative signal strength is a number between 0 and MAX_STRENGTH, where 0 is strongest signal and MAX_STRENGTH is the weakest, the relative distance corresponding to a signal strength of value “strength” is

relative distance=strength/MAX_STRENGTH

Alternatively, if signal strength of 0 represents the weakest signal and MAX_STRENGTH is the strongest, then the formula is

relative distance=(MAX_STRENGTH−strength)/MAX_STRENGTH

It is however clear to a person who is skilled in the art that other ways of determining the relative distance may be applied in other embodiments of the invention, as well as non-linear conversion formulas, many of which are known in the art.

Once relative distances (or signals strengths) between multiple devices in the vicinity of the first device have been collected, the first device proceeds to providing to a user of the first device location information representative of the locations of other devices in the vicinity of the first device, and especially of the second device and of the third device (usually by displaying a representation of the devices on its screen).

The providing of the location information requires estimating, by the first device, of locations of the other devices (e.g. the second device and the third device) in response to the relative distances between multiple device (e.g. in response to a content of the strength indication signal and in response to a strength of a signal that is received by the first device and was transmitted by the second device). The following stages may be carried out, according to an embodiment of the invention, by the first device for providing the location information:

Firstly, averaging the relative distances between pairs of devices (e.g. the second device and the third device). for example, if according to device A the relative distance between it and device B is 0.2, and according to device B the relative distance between it and device A is 0.24, then the calculated average of 0.22 will conveniently be used as the formal relative distance between device A and device B. It is however noted that the averaging is not necessary, and that the relative distance between any two devices may be provided to any of them by only one of them (e.g. the third device is not required to provide information regarding to the second device), or the first device may choose to use only a signal strength indication that is received from one of the devices, or to otherwise average between the signal strength indication received from each of the devices.

Once the formal relative distances were determined (e.g. by averaging), the process continues with calculating relative coordinates for each symbol representative of a location of a device (by way of example, a second symbol would represent an estimated location of the second device, and a third symbol would represent an estimated location of the third device, and so forth, wherein it is noted that not all the symbols should be graphically distinctive from each other, and that identifying information may be provided on request or by other means such as adjacent text); wherein the calculating of the relative coordinates pertains usually to a location of the symbols on the display of the first device, and it is conveniently based on all available relative distances between pairs of devices.

The relative coordinates are usually circular coordinates (while it is noted that the other coordinate systems that are known in the prior art may be implemented, such as spherical coordinates), wherein the calculating usually includes calculating a selected angle of rotation (e.g. 0 degrees, π/2, etc') using trilateration.

It is clear to a person who is skilled in the art that since the relative coordinates are calculated based only on distances information, the direction of the different symbols (representing devices) needs to be determined arbitrarily, e.g. by using one of the devices (preferably one that is previously known to the first device) as a reference; thus the location information if illustrated graphically may require a rotating before the directions of the symbols could indicate a direction of the actual devices represented in relation to the first device.

Additionally, for the same reason, a certain device may have potentially several different positions (for example, usually two mirror symmetrical location representations could not be selected between without being distinguished between by the user). For this reason there may be several possible solutions, wherein each potential layout is referred to as a layout option. Conveniently, two or more of the layout options will be displayed to the user by the first device, and the user will be able to flip through the different layout options and try to match it with reality.

The calculating is conveniently followed by scaling the relative coordinates in response to a size of the display of the first device, which is followed by displaying the symbols representative of device according to the scaled relative coordinates. By way of example, each device may be represented by a small circle of a certain color.

Conveniently, the providing of the location information (e.g. by the aforementioned discussed way of map including symbols) includes maintaining an association between the devices and the symbols representing them on the screen, so that when a symbol is selected by the user (e.g. while positioning a mouse pointer over the symbol), information pertaining to the device may appear (e.g. as in a tool tip), like showing relevant info such as the device's Bluetooth ID or friendly name, and when available, provide information from the device identifiers database (described above) associated with the pointed at device.

It is noted that the estimated location of some devices may be determined as a single location, or as several (usually two) locations, wherein different representative symbols may be used (e.g. a filled circle in the first case, as opposed to a non-filled circle in the second case).

Additionally, according to an embodiment of the invention, the display may include lines drawn between devices so as to show their binding, wherein a binding means that even if the angle or rotation changes, the orientation between the bound devices remains constant. so for example if there exist more than one location for a certain device A but it is bound to device B, then there will be a special decorated line between B and the two A's (e.g. dashed line); if there is only one solution then the line might be solid.

It is noted that relative locations of devices may usually be determined only within a group of devices that can provide strength indication signals representative of strengths of signals that was transmitted between them, and thus several independent group of symbols may be formed, and displayed to the user. Note that the first device may display all the devices in all their possible locations in one view, or it may just show a single potential solution at a time. The display may contain several such clusters (e.g. represented as symbols connected by lines) in which there is no line connecting one cluster to another. This means that there is no binding between them and the orientation of one cluster to another was arbitrarily chosen by the first device.

Therefore, conveniently the first device is adapted to provide the user with means to orient the display so as to match physical orientation. So that, on top of being adapted to display a map that includes multiple symbols that represent the possible locations of the multiple devices, the first device is further capable of rotating the map in response to the user provided location information.

The user interface of the first device will conveniently allow the user to rotate the content displayed on the display, to any angle of rotation. The user may specify the angle or can ask the device to rotate it by some increments, until the user sees on his display the devices oriented in the same manner in which they are oriented physically in front of his/her eyes.

Since, as aforementioned, there may be several possibilities to the orientation, the first device may inform the user of how many solutions there are, for a given angle of rotation (normally there should be two solutions). The first device may show the solutions with dashed lines as described above or it may allow the user to flip through the different solutions, showing them one at a time, so that the user can choose the one that matches reality.

Conveniently, the first device providing the user the means to select a device on the screen. The first device is conveniently adapted to receive from the user of the first device a request to communicate with another device (e.g. the second device) via a communication channel (which may be either a short range or a non-short range communication channel); and to initiate a communication with that device via the communication channel.

For example, the first device enables the user to select the symbol representative of the desired device (which may also have a convenient name assigned to it by the software, such as a simple 1 or 2 digit or letters which makes it easy for the user to select a device by its name, in devices which lack the means of a graphical pointer), and to perform a user selected action on the selected device.

Once the desired device has been selected by the user, the user can select an action, from a set of choices presented to it, and apply it to the selected device, e.g. initiating communication with the selected device.

The advantage of the solution described below is that the first device may initiate communication with another device and then communicate bi-directionally with the other device while the phone number (or like device identifier) of each device is not revealed to the other.

The first device may initiate communication with the selected device in two main methods, according to some embodiments of the invention:

The first method for initiating communication is by direct initiation of communication by the first device with the selected device, wherein the first device may invoke a service on the selected device. For example, the first device may prompt the user for a message; after the user types the message in, the first device may invoke a note passing service on the selected device passing to the service the message typed by the user.

The note passing service on the selected device may display the message to its user (referred to as the receiver); wherein it may optionally further provide the receiver with a choice to respond, while it can respond by sending the response back to the same service on the first device, provided that the first device also passed its Bluetooth ID (or other device identification information) along with its original request to the note passing service of the selected device.

The passed message may be of one or more types of media, such as—though not limited to—text, voice, video, file transfer, and so forth. When voice or video is transmitted, for example, the first device can record the voice/video message, and the selected device will play/show it to the receiver.

The first device may also engage in a series of interactions with the selected device, wherein in each interaction some service is called by one device on the other, and various data may be passed to each service. Those interactions may or may not involve the users of the respective devices.

The first method for initiating communication is by indirect initiation of communication by the first device via a server. The first device may send a request to some remote service/server (e.g. by sending an http request) requesting to initiate a call with the selected device. The first device may pass along with the request its Bluetooth ID or phone number (or other communication identifier), and the selected device Bluetooth ID (or other device identifier thereof).

Once the server/service receives that request, it can look for the phone number or other identity of the selected device as a mapping from the Bluetooth ID of the device (or using other types of communication identifiers), and then initiate a call between the first device and the selected device. The users of the respective devices (i.e. the user and the receiver) will be communicating without still one knowing the phone number of the other. Similarly to the first method, a video call or an IM session may be initiated between the two devices.

The first device may also, according to an embodiment of the invention, ask the selected device to initiate a call to the first device; this is done by invoking, as before, a service on the selected device passing the Bluetooth ID (or other device identifier) as well as a potential message. The invoked service of the selected device may prompt its user for approval and then if approved, invoke the service described above.

Similarly, the requesting device may send an SMS to the selected device by first prompting the user of the first device from the message, and then invoking a remote service/server passing the message along. The remote server, after looking up the selected device phone number or other ID, may send an SMS to the selected device containing the message typed by the user of the first device. The server may in addition provide the receiver a choice of responding to the SMS, while keeping all phone numbers in confidence.

This may be done by the server by sending the SMS with a response-code to which to reply. this response-code is mapped by the server to the first device before the SMS is sent. When the selected device responds by sending an SMS to the response-code, the server determines the first device from the mapping based on the response-code and routes the response SMS to the first device. This allows the first device and the selected device to communicate back and forth using SMS while not sharing their phone number with each other.

It is noted that while above, a solution regarding to a peer to peer system in which collaborative devices communicate strength/distance information among themselves and a graphical representation is created by one or more of the devices, a Client/Server variation of the solution can also be implemented. It is possible to use a server in the process of the creation of the graphical representation of the devices. This solution may be implemented, according to an embodiment of the invention, as follows.

The first device performs the detection of devices and their strengths as above. the first device then communicates to its peers as above requesting strengths/distances of its detected device list (as before) but also sends this information to a server (e.g. via HTTP) requesting the graphical representation of the devices (an image) and other data (A) or calculated information as to the location of each device and the binding information (B). When the server responds to this request, the first device displays the image (A) or creates the image from the passed information (B) and then displays it.

Clearly, before the server can respond, it needs information from the other devices. Rather than each device communicating the strengths/distance information back to the first device, the other devices can communicate such information back to the server (e.g. via HTTP), which can use the data received from the first device and all the detected devices to calculate the positions of each device relative to each other, and can then respond to the first device with that data. Additionally, the server can also create an image representation of the location, in relation to the first device, and to send it to the first device.

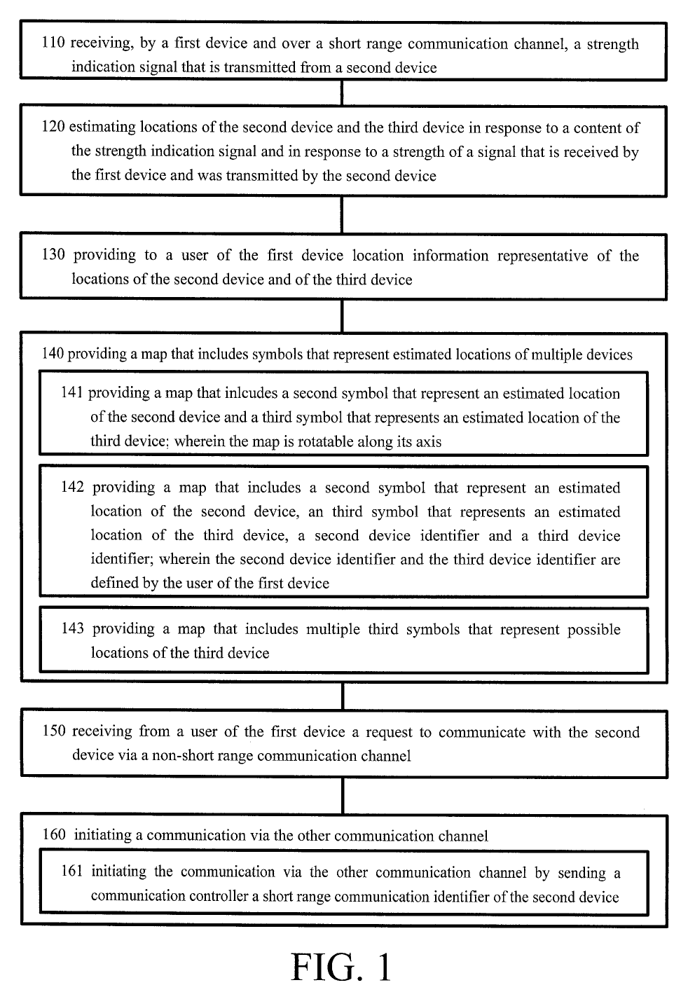

FIG. 1 illustrates method 100 for exchanging short range information, according to an embodiment of the invention. It is noted that conveniently, method 100 is adapted to be carried out by the aforementioned first device, and that embodiments of the invention referred to in relation to the aforementioned first device may be implemented in method 100 an vice versa.

It will be clear to a person who is skilled in the art that method 100 can be implemented in regard to multiple other devices (some of which acting as second devices, some of which acting as third devices, and some of which acting as both second and third devices), e.g. in a manner corresponding with the above description.

Method 100 starts with stage 110 of receiving, by a first device and over a short range communication channel, a strength indication signal that is transmitted from a second device; wherein the strength indication signal is representative of a strength of a signal that was transmitted by the third device and was received by the second device.

Stage 110 is followed by stage 120 of estimating locations of the second device and the third device in response to a content of the strength indication signal and in response to a strength of a signal that is received by the first device and was transmitted by the second device.

Stage 120 is followed by stage 130 of providing to a user of the first device location information representative of the locations of the second device and of the third device.

According to an embodiment of the invention, method 100 further includes stage 140 of providing a map that includes symbols that represent estimated locations of multiple devices. The map is conveniently provided to the user on a display of the first device, wherein, as aforementioned, the symbols may be identical to each other, different from one another, or be of different types, wherein each type of symbol conveys additional information pertaining to the devices represented by which or to the locations thereof.

According to an embodiment of the invention, method 100 includes stage 141 of providing a map that includes a second symbol that represent an estimated location of the second device and a third symbol that represents an estimated location of the third device; wherein the map is rotatable along its axis.

According to an embodiment of the invention, method 100 includes stage 142 of providing a map that includes a second symbol that represent an estimated location of the second device, an third symbol that represents an estimated location of the third device, a second device identifier and a third device identifier; wherein the second device identifier and the third device identifier are defined by the user of the first device.

According to an embodiment of the invention, method 100 includes stage 143 of providing a map that includes multiple third symbols that represent possible locations of the third device.

According to an embodiment of the invention, method 100 further includes stage 150 of receiving from a user of the first device a request to communicate with the second device via a non-short range communication channel, that is conveniently followed by stage 160 of initiating a communication via the other communication channel. It is clear to a person who is skilled in the art a request to communicate with the third device may also be received, wherein the initiating of the communication will in such a case will be with the third device.

According to an embodiment of the invention, stage 160 includes stage 161 of initiating the communication via the other communication channel by sending a communication controller a short range communication identifier of the second device.

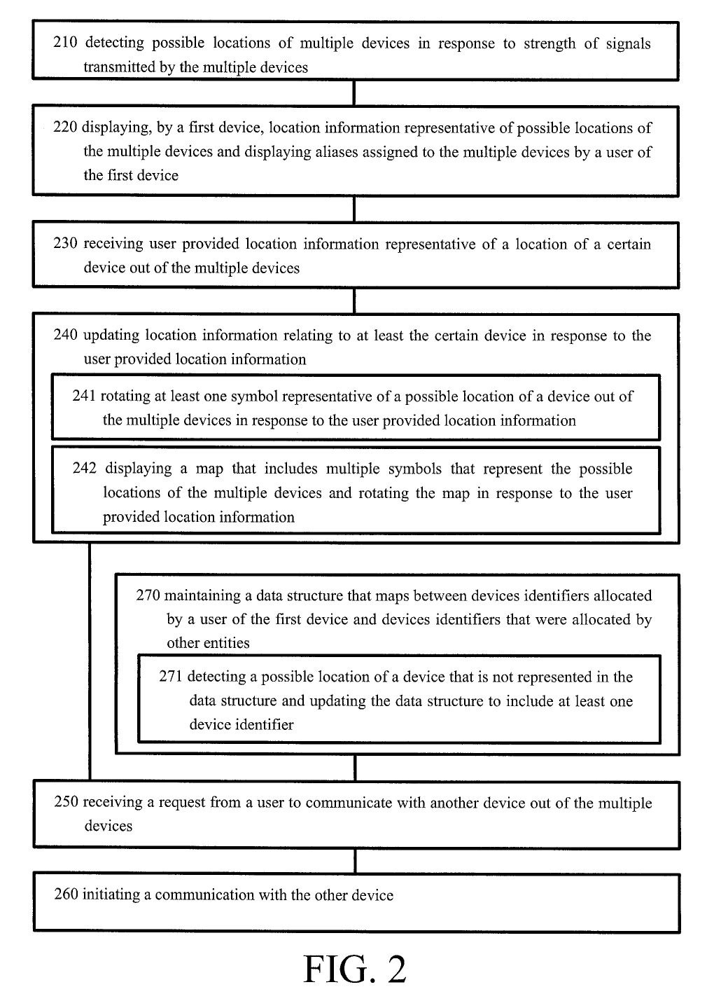

FIG. 2 illustrates method 200 for exchanging short range information, according to an embodiment of the invention. It is noted that conveniently, at least some of the stages of method 200 are to be carried out by the aforementioned first device, and that embodiments of the invention referred to in relation to the aforementioned first device may be implemented in method 200 an vice versa. It is however noted that, according to an embodiment of the invention, at least some of the stages of method 200 may be carried by a server, as disclosed above, mutatis mutandis.

It will be clear to a person who is skilled in the art that method 200 can be implemented in regard to multiple other devices (some of which acting as second devices, some of which acting as third devices, and some of which acting as both second and third devices), e.g. in a manner corresponding with the above description.

Method 200 stages with stage 210 of detecting possible locations of multiple devices in response to strength of signals transmitted by the multiple devices.

Stage 210 is followed by stage 220 of displaying, by a first device, location information representative of possible locations of the multiple devices and displaying aliases assigned to the multiple devices by a user of the first device.

Stage 220 is followed by stage 230 of receiving user provided location information representative of a location of a certain device out of the multiple devices.

Stage 230 is followed by stage 240 of updating location information relating to at least the certain device in response to the user provided location information.

According to an embodiment of the invention, method 200 further includes stage 241 of rotating at least one symbol representative of a possible location of a device out of the multiple devices in response to the user provided location information.

According to an embodiment of the invention, method 200 further includes stage 242 of displaying a map that includes multiple symbols that represent the possible locations of the multiple devices and rotating the map in response to the user provided location information.

Stage 240 is followed by stage 250 of receiving a request from a user to communicate with another device out of the multiple devices.

Stage 250 is followed by stage 260 of initiating a communication with the other device.

According to an embodiment of the invention, method 200 further includes stage 270 of maintaining a data structure that maps between devices identifiers allocated by a user of the first device and devices identifiers that were allocated by other entities.

According to an embodiment of the invention in which such data structure is maintained, method 200 further includes stage 271 of detecting a possible location of a device that is not represented in the data structure and updating the data structure to include at least one device identifier.

It is noted that methods 100 and 200, as well as embodiments of the first, second, and third devices as disclosed above which, may be implemented by way of one or more computer program products, each of which includes a computer usable medium including a computer readable program, wherein the computer readable program—when executed on a computer of a first device—causes the computer to carry out a method or a process according to the invention, such as method 100, method 200, or methods and processes as discussed above.

According to an aspect of the invention, a first computer program product is disclosed, the first computer program product including a first computer usable medium including a first computer readable program, wherein the first computer readable program when executed on a computer of a first device causes the computer to: (a) estimate locations of a second device and a third device in response to a strength indication signal and in response to a strength of a signal that was transmitted from the second device and was received by the first device; wherein the strength indication signal was received by the first device after being transmitted by the second device and over a short range communication channel; wherein the strength indication signal is representative of a strength of a signal that was transmitted by the third device and was received by the second device; and to (b) provide to a user of the first device location information representative of the locations of the second device and of the third device.

According to an embodiment of the invention, the first computer program product also causes the computer to provide a map that includes a second symbol that represent an estimated location of the second device and an third symbol that represents an estimated location of the third device; wherein the map is rotatable along its axis.

According to an embodiment of the invention, the first computer program product also causes the computer to provide a map that includes a second symbol that represent an estimated location of the second device, an third symbol that represents an estimated location of the third device, a second device identifier and a third device identifier; wherein the second device identifier and the third device identifier are defined by the user of the first device.

According to an embodiment of the invention, the first computer program product also causes the computer to provide a map that includes multiple third symbols that represent possible locations of the third device.

According to an embodiment of the invention, the first computer program product further causes the computer to: (a) receive from a user of the first device a request to communicate with the second device via a non-short range communication channel; and (b) initiate a communication via the other communication channel.

According to an embodiment of the invention, the first computer program product further causes the computer to provide initiate the communication via the other communication channel by sending a communication controller a short range communication identifier of the second device.

According to an aspect of the invention, a second computer program product is disclosed, the second computer program product including a second computer usable medium including a second computer readable program, wherein the second computer readable program when executed on a computer of a second device causes the computer to: (a) detect possible locations of multiple devices in response to strength of signals transmitted by the multiple devices; (b) display, by a first device, location information representative of possible locations of the multiple devices and displaying aliases assigned to the multiple devices by a user of the first device; (c) receive user provided location information representative of a location of a certain device out of the multiple devices; (d) update location information relating to at least the certain device in response to the user provided location information; (e) receive a request from a user to communicate with another device out of the multiple devices; and (f) initiate a communication with the other device.

According to an embodiment of the invention, the second computer program product also causes the computer to rotate at least one symbol representative of a possible location of a device out of the multiple devices in response to the user provided location information.

According to an embodiment of the invention, the second computer program product also causes the computer to maintain a data structure that maps between devices identifiers allocated by a user of the first device and devices identifiers that were allocated by other entities.

According to an embodiment of the invention, the second computer program product also causes the computer to detect a possible location of a device that is not represented in the data structure and updating the data structure to include at least one device identifier.

According to an embodiment of the invention, the second computer program product also causes the computer to display a map that includes multiple symbols that represent the possible locations of the multiple devices and rotating the map in response to the user provided location information.

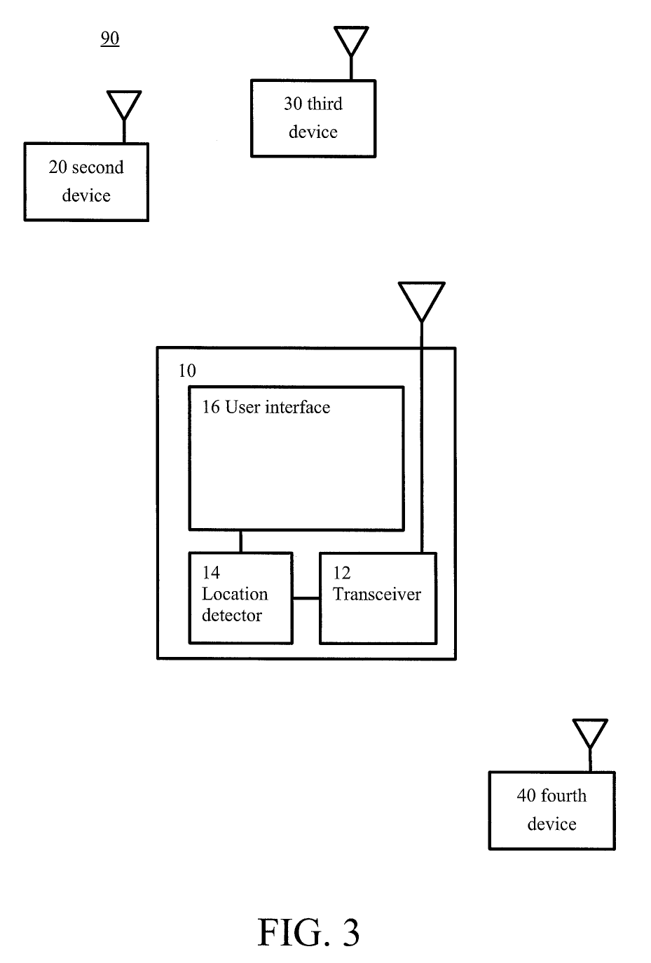

FIG. 3 illustrates mobile device 10, according to an embodiment of the invention. It is noted that conveniently, mobile device 10 can act as the aforementioned first device, and that, according to different embodiment of the invention, mobile device 10 may carry out method 100 or at least stages thereof, and/or method 200 or at least stages thereof. Additionally, according to an embodiment of the invention, mobile device 10 may include the first computer program product, the second program product, or both.

It should be noted that mobile device 10 may be a mobile device of different types, such as—though not limited to—a personal digital assistant (PDA), a mobile phone, a laptop computer, and so forth. Conveniently, mobile device 10 supports Bluetooth communication, and also at least one other type of communication capabilities (such as cellular telephony communication, wireless fidelity—Wi-Fi communication, and so forth).

Mobile device 10 includes transceiver 12 that is adapted to exchange signals over a short range communication channel; and location detector 14 that is adapted to detect possible locations of multiple devices (generally denoted 90; in FIG. 3 illustrated are second device 20, third device 30, and fourth device 40, while it is noted that other amounts of devices may be supported) in response to strength of signals transmitted by the multiple devices 90. Mobile device 10 further includes user interface 16, which is adapted to: (i) display location information representative of possible locations of the multiple devices 90 and displaying aliases assigned to the multiple devices 90 by a user of mobile device 10; (ii) receive user provided location information representative of a location of a certain device out of the multiple devices 90.

Referring again to location detector 14, it is noted that location detector 14 is further adapted to update location information relating to at least the certain device in response to the user provided location information. Referring to user interface 16, it is noted that user interface 16 is further adapted to receive a request from a user to communicate with another device out of the multiple devices 90, wherein transceiver 12 initiates a communication with the other device (e.g. with second device 20).

According to an embodiment of the invention, mobile device 10 adapted to rotate at least one symbol representative of a possible location of a device out of the multiple devices 90 in response to the user provided location information.

According to an embodiment of the invention, transceiver 12 is adapted to receive a strength indication signal that is transmitted from second device 20; wherein the strength indication signal is representative of a strength of a signal that was transmitted by third device 30 and was received by second device 20; and wherein the location detector 14 is adapted to estimate locations of second device 20 and of third device 30 in response to a content of the strength indication signal and in response to a strength of a signal that is received by mobile device 10 and was transmitted by second device 20.

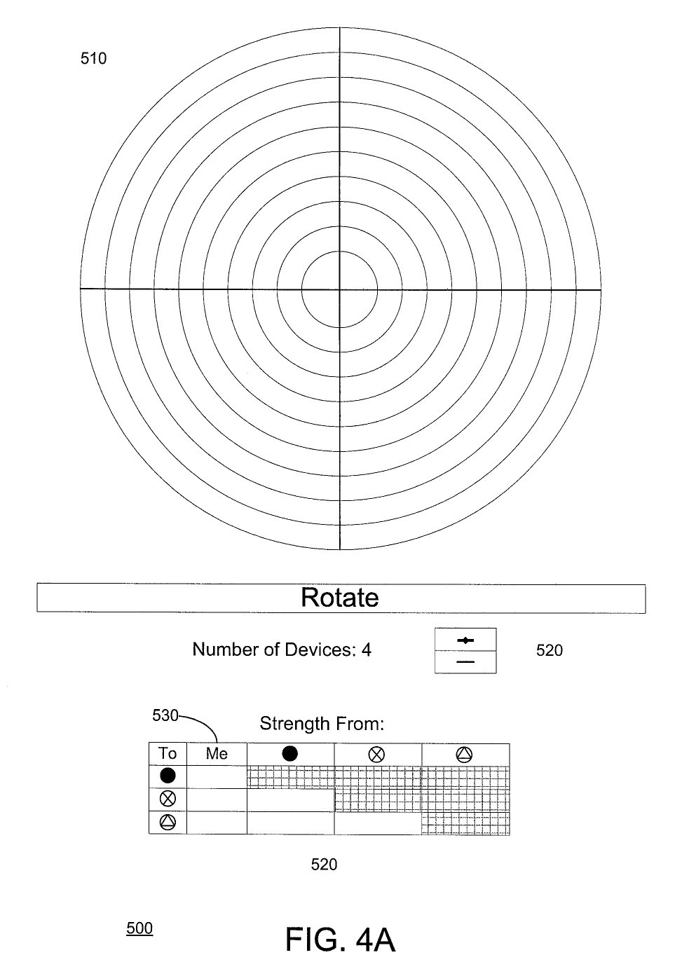

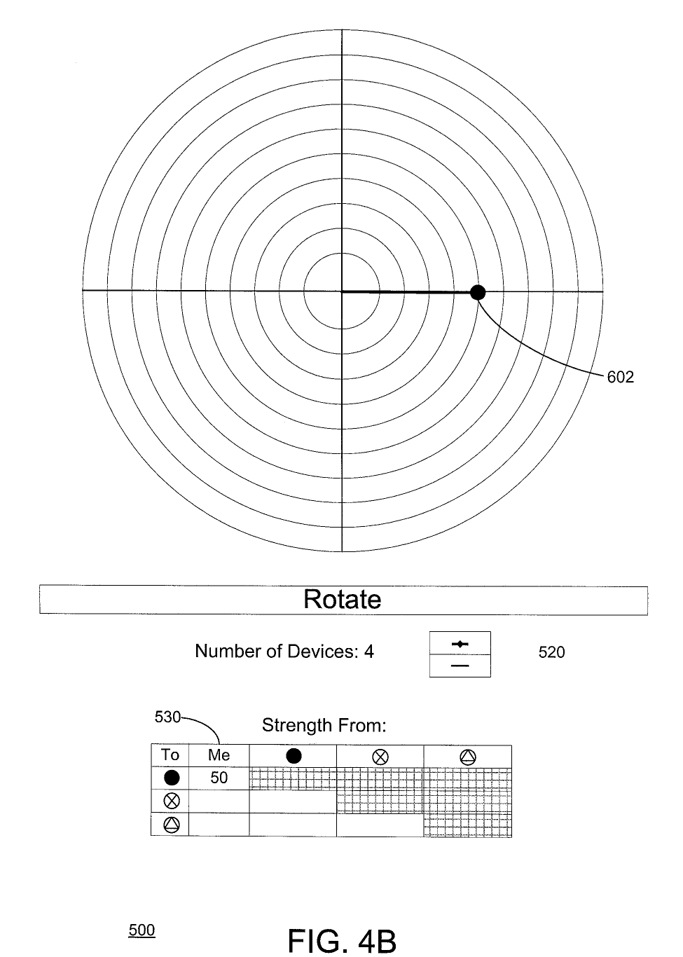

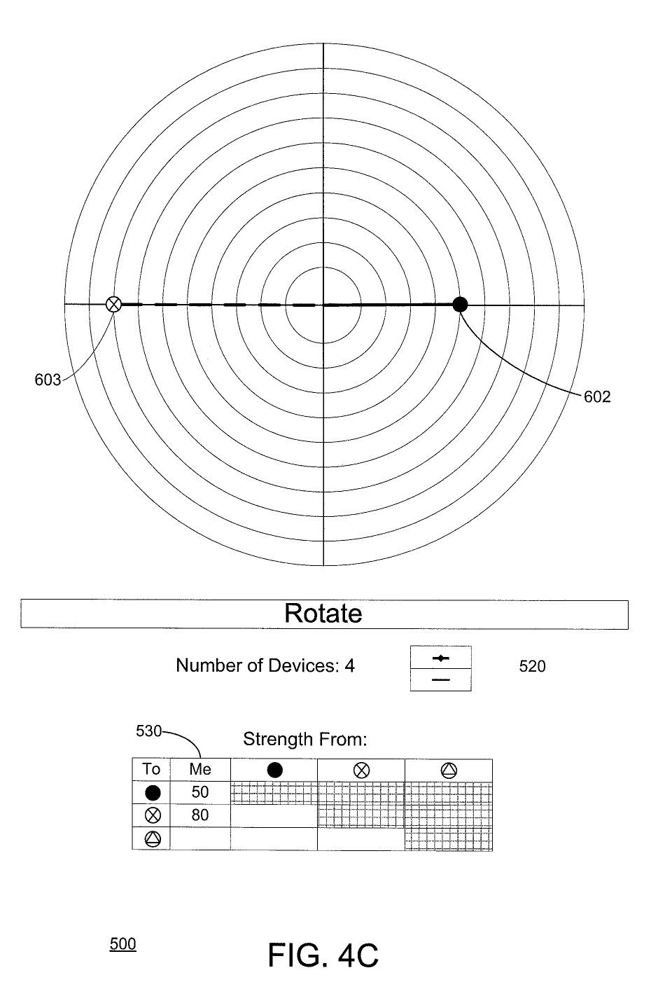

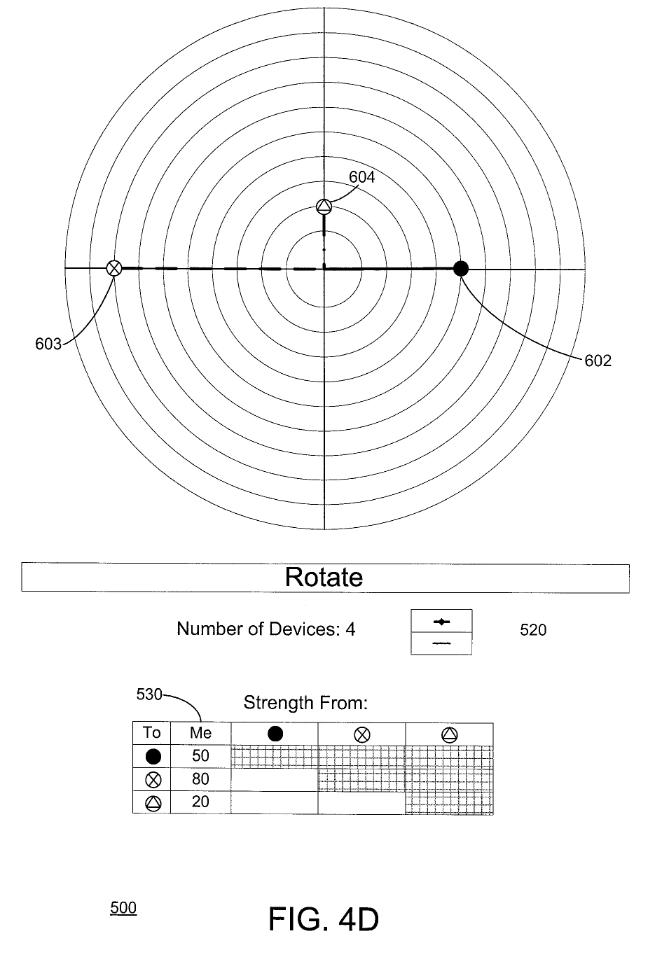

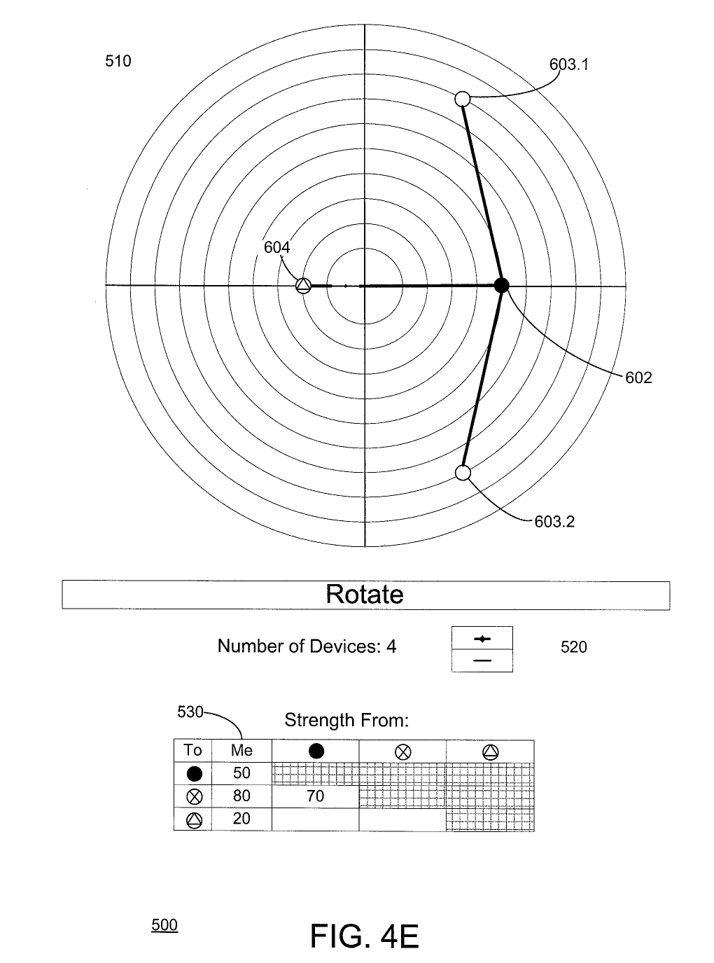

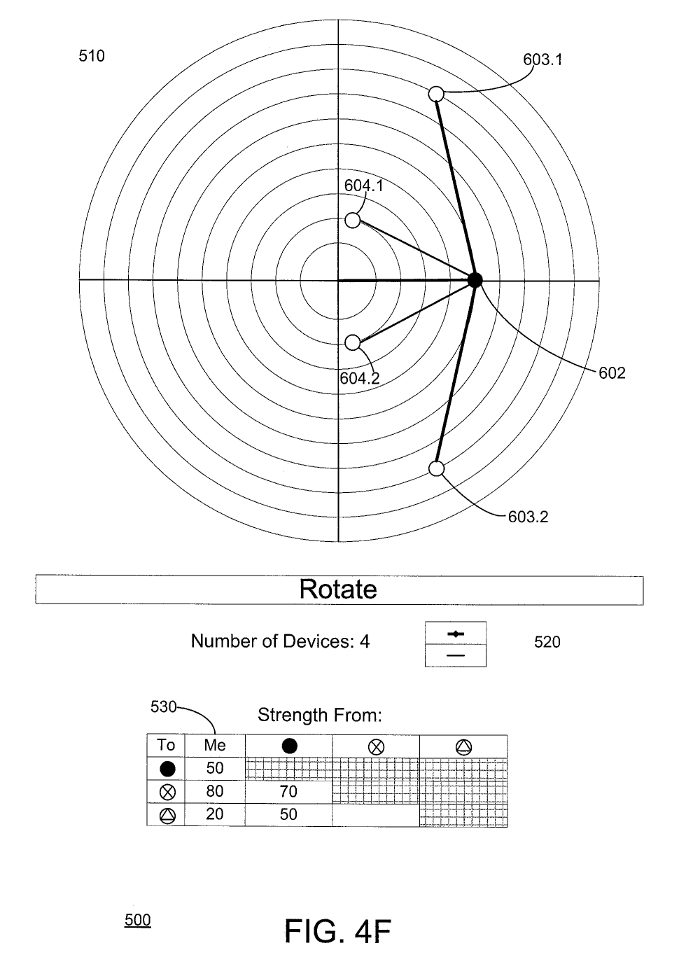

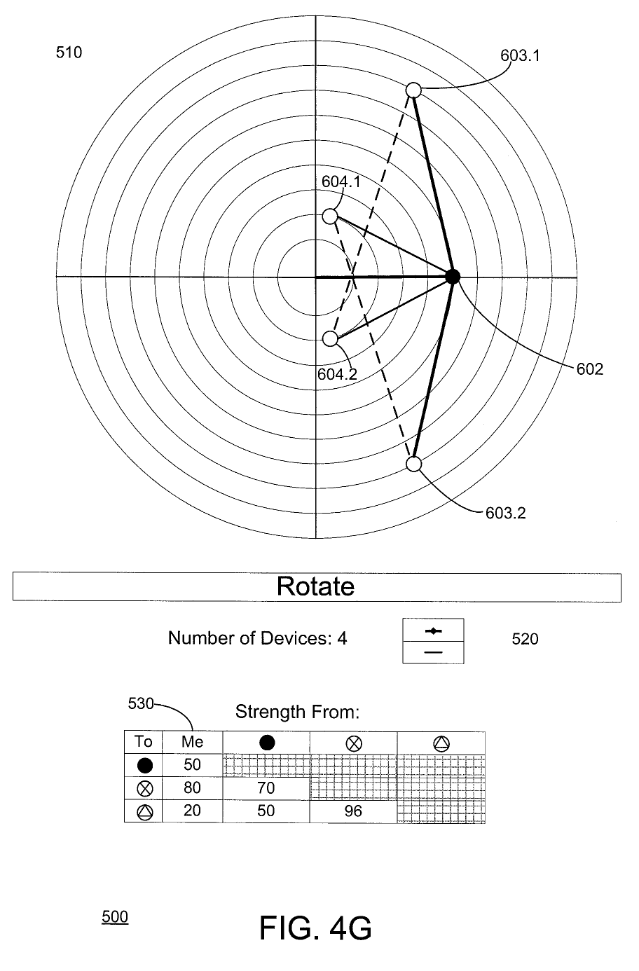

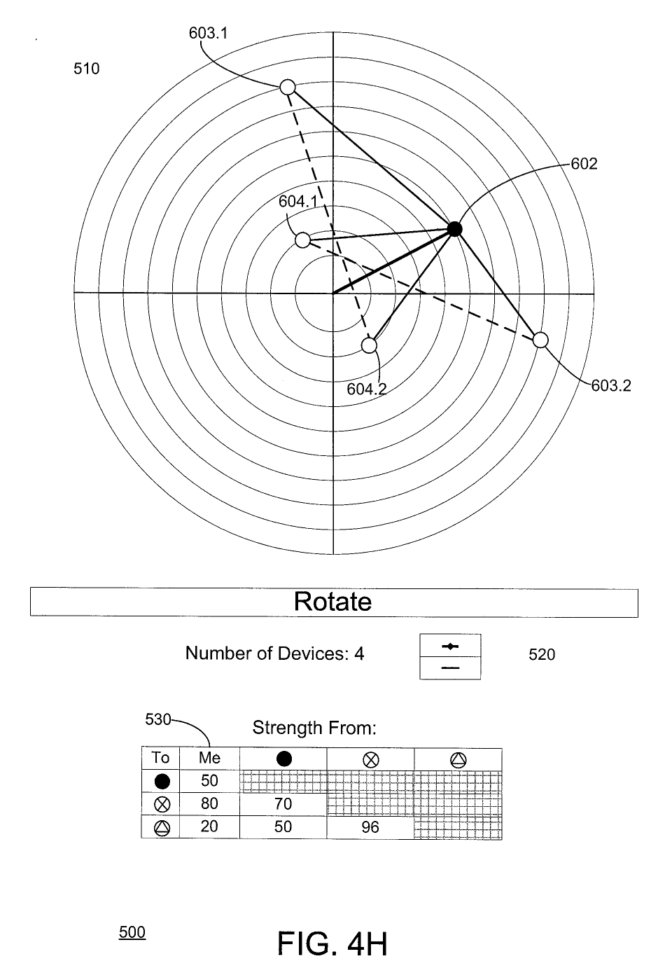

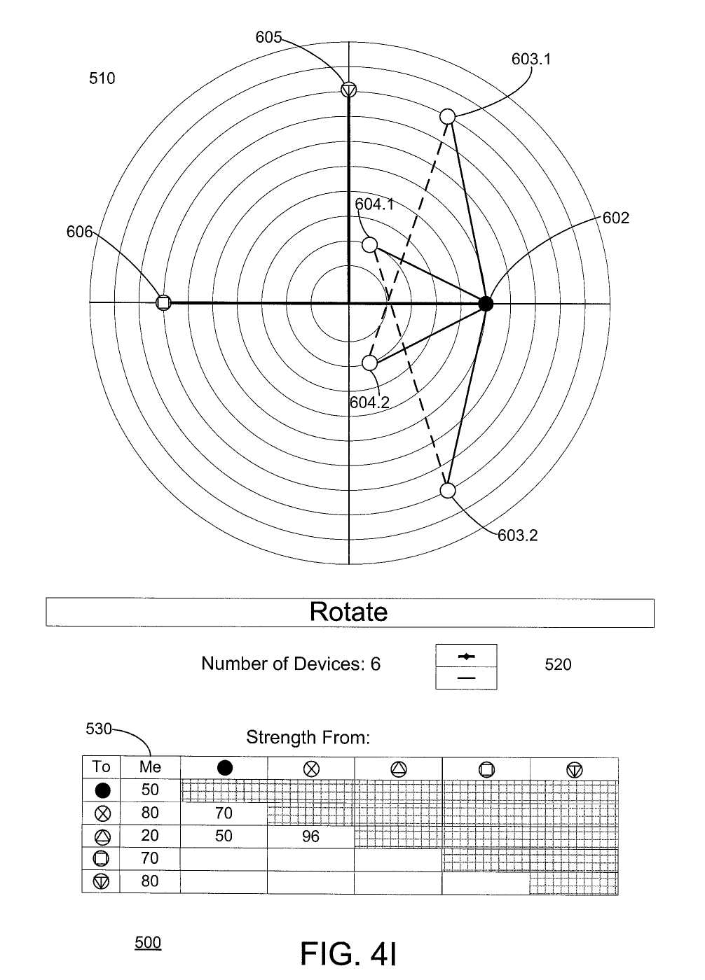

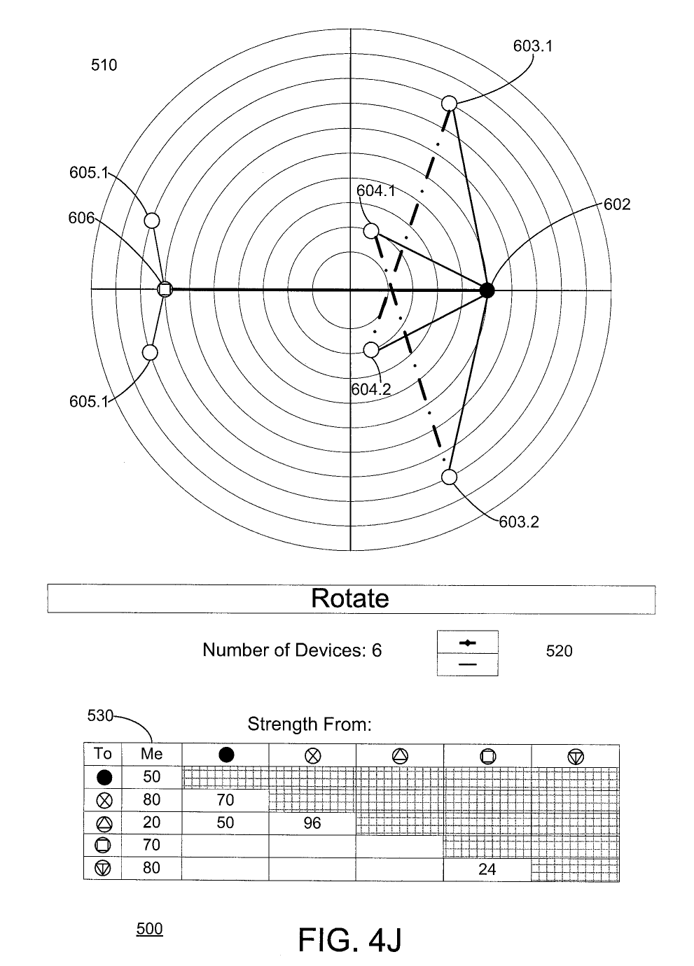

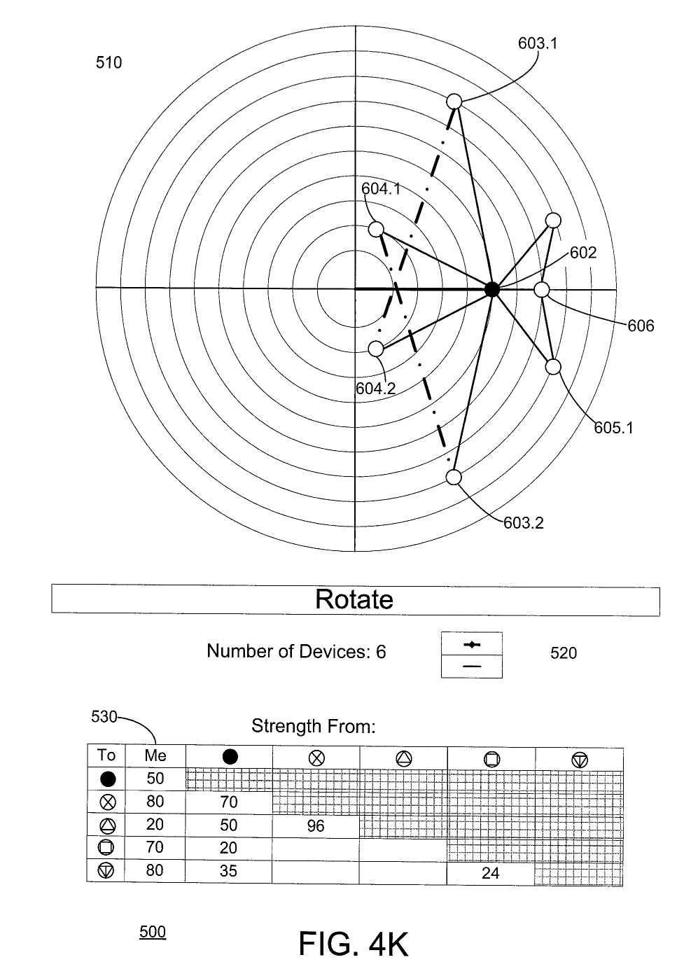

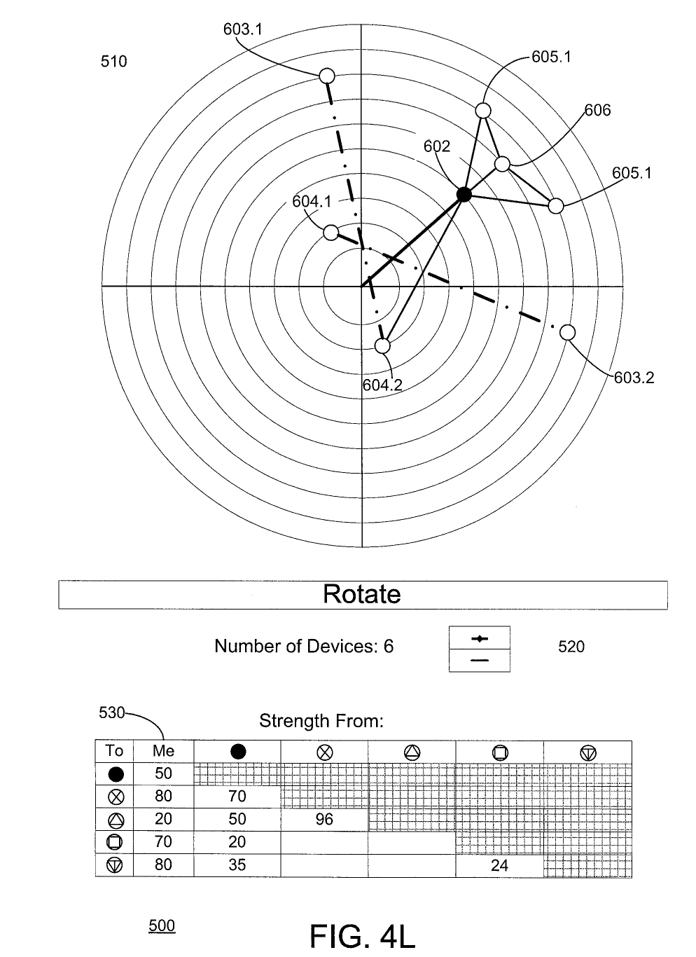

FIGS. 4A through 4L illustrate display 500 of the first device (which may be mobile device 10), according to an embodiment of the invention. FIGS. 4A through 4L are ordered, so that the displayed information as illustrated in FIG. 4B pertains to a moment in time that is later than the one pertained to by the displayed information of FIG. 4A, and so forth. The changes leading to the differences in the displayed information illustrated in the different FIGS. 4A through 4L is discussed below, while it should be noted that the illustrated displays 500 are offered only by way of explanation, in order to clarify an aspect of the invention, and are not intended to limit the scope of the invention in any way.

In each of FIGS. 4A through 4L display 500 includes map 510 in which symbols (denoted 602, 603 and so forth) may be included. Display 500 in the embodiment illustrated also includes control interface 520, that enables the user to control features of the display (such important feature may be a rotation of map 510, so as to facilitate orientation of the user when using the map, but other features such as displaying parameters, zooming in and out, and so forth). Other parameters controllable via control interface 520 may be the number of devices displayed (e.g. may be automatically selected by proximity to the first device, but may also be controlled by the user), and so forth.

Array 530 includes information pertaining to the strength of signals between any two devices. It is noted that array 530 includes information that usually is not required for the user, but is useful for the exemplification.

Referring to FIG. 4A, when the application starts, the orbital grid (which is how map 510 is displayed according to the illustrated embodiment) is displayed, wherein the location of the first device is assumed in the center of the orbital grid (a first symbol, which is not illustrated, may be used to indicate the location of the first device; in the illustration the origin of axes is used as the first symbol). No other devices are shown, as no information is received from any device yet.

Referring now to FIG. 4B, once the first device has received a signal that was transmitted by a second device (e.g. second device 20 of FIG. 3), and estimated it's strength and following which the relative distance therefrom, a corresponding symbol (i.e. second symbol 602) can be drawn on map 510. Since no direction information is currently available, second symbol 602 is arbitrarily placed, in a distance responsive to the relative distance from the second device.

Referring now to FIG. 4C, once the first device has received a signal that was transmitted by a third device (e.g. third device 30 of FIG. 3), and estimated it's strength and following which the relative distance therefrom, a corresponding symbol (i.e. third symbol 603) can be drawn on map 510. Since no direction information is currently available, third symbol 603 is placed as far from second symbol 602 as possible over the 360 range, so as to limit cluttering in the future, in a distance responsive to the relative distance from the third device.

Referring now to FIG. 4D, once the first device has received a signal that was transmitted by a fourth device (e.g. fourth device 40 of FIG. 3), and estimated it's strength and following which the relative distance therefrom, a corresponding symbol (i.e. fourth symbol 604) can be drawn on map 510. Since no direction information is currently available, third symbol 603 is placed as far from second symbol 602 and from third symbol 603 as possible over the 360 range, so as to limit cluttering in the future, in a distance responsive to the relative distance from the fourth device. It is noted that the location of previously displayed symbols may be changed so as to avoid cluttering; however, this may confuse the user and thus is not implemented in the illustrated embodiment.

Referring now to FIG. 4E, once the first device had received over a short range communication channel a strength indication signal that is transmitted from the second device; wherein the strength indication signal is representative of a strength of a signal that was transmitted by the third device and was received by the second device, the relative distance between the second device and the third device (in the example offered, 70) could be determined. It is noted that the third device may be in each of two locations in relation to the second device and to the first device, and thus two third symbols (denoted 603.1 and 603.2) are included in map 510, wherein the unfilled circle used for each of the third symbols 603.1 and 603.2 indicates to the user that the third device may be in one of the two illustrated locations.

It is noted that in the example illustrated in FIGS. 4A through 4L, think lines connecting between any two devices represent strong relationships between the two connected devices; while thin lines represent possible relationships, meaning it's a possible relation between the two connected devices, and other relations may apply.

It should be noted that fourth symbol 604 that illustrates an estimated location of the fourth device was moved, so as to maintain as little clutter as possible.

Referring now to FIG. 4F, once the first device had further received over a short range communication channel a strength indication signal that is transmitted from the second device; wherein the strength indication signal is representative of a strength of a signal that was transmitted by the fourth device and was received by the second device, the relative distance between the second device and the fourth device (in the example offered, 50) could be determined. It is noted that the fourth device may be in each of two locations in relation to the second device and to the first device, and thus two fourth symbols (denoted 604.1 and 604.2) are included in map 510, wherein the unfilled circle used for each of the fourth symbols 604.1 and 604.2 indicates to the user that the fourth device may be in one of the two illustrated locations.

Referring now to FIG. 4G, once the first device had further received over a short range communication channel a strength indication signal that is representative of a strength of a signal that was transmitted between the third and the fourth devices, the relative distance between the third device and the fourth device (in the example offered, 96) could be determined. At this point, there are only two possible layouts (as opposed to the four possible layouts illustrated in FIG. 4F), relative to the shown angle of rotation. As aforementioned, the display may only include one of the layouts, and indicate that a second layout is available.

Referring now to FIG. 4H, the angle of rotation of map 510 may be changed, e.g. in response to user provided location information (which may be received via control interface 520). The rotating allows the user to try to match the displayed orientation to the actual people/entities/devices orientations he sees around.

Referring now to FIG. 4I, as the fifth and sixth devices (illustrated by fifth symbol 605 and sixth symbol 606, respectively) enter the range, they are sensed by the first device, and their position is distributed on the orbital grid, usually so as to limit cluttering.

Referring now to FIG. 4J, FIG. 4J illustrates display 500 after information pertaining to the distance between the fifth and the sixth device was retrieved by the first device (wherein the fifth symbols denoted 605.1 and 605.2 illustrates two locations wherein the fifth device may be located). FIG. 4K illustrates after information pertaining to the distance between the second and the fifth device and to the distance between the second and the sixth device was retrieved by the first device. FIG. 4L illustrates display 500 after rotation of map 510 by the user.

Furthermore, the invention can take the form of a computer program product accessible from a computer-usable or computer-readable medium generating program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can store information that can be read by electronic, magnetic, optical, electromagnetic or infrared based techniques, or semiconductor system (or apparatus or device). Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which generate temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the claims.

We claim:

1. A method for exchanging short range information, the method comprises:
receiving, by a first device and over a short range communication channel, a strength indication signal that is transmitted from a second device; wherein the strength indication signal is representative of a strength of a signal that was transmitted by a third device and was received by the second device;
estimating locations of the second device and the third device in response to a content of the strength indication signal and in response to a strength of a signal that is received by the first device and was transmitted by the second device; and
providing to a user of the first device location information representative of the locations of the second device and of the third device.

2. The method according to claim 1 comprising providing a map that comprises a second symbol that represent an estimated location of the second device and a third symbol that represents an estimated location of the third device; wherein the map is rotatable along its axis.

3. The method according to claim 1 comprising providing a map that comprises a second symbol that represent an estimated location of the second device, an third symbol that represents an estimated location of the third device, a second device identifier and a third device identifier; wherein the second device identifier and the third device identifier are defined by the user of the first device.

4. The method according to claim 1 comprising providing a map that comprises multiple third symbols that represent possible locations of the third device.

5. The method according to claim 1 comprising:
receiving from a user of the first device a request to communicate with the second device via a non-short range communication channel; and
initiating a communication via the other communication channel.

6. The method according to claim 5 comprising initiating the communication via the other communication channel by sending a communication controller a short range communication identifier of the second device.

7. A method for exchanging short range information, the method comprises:
detecting possible locations of multiple devices in response to strength of signals transmitted by the multiple devices;
displaying, by a first device, location information representative of possible locations of the multiple devices and displaying aliases assigned to the multiple devices by a user of the first device;
receiving user provided location information representative of a location of a certain device out of the multiple devices;
updating location information relating to at least the certain device in response to the user provided location information;
receiving a request from a user to communicate with another device out of the multiple devices; and
initiating a communication with the other device.

8. The method according to claim 7 comprising rotating at least one symbol representative of a possible location of a device out of the multiple devices in response to the user provided location information.

9. The method according to claim 7 comprising maintaining a data structure that maps between devices identifiers allocated by a user of the first device and devices identifiers that were allocated by other entities.

10. The method according to claim 9 comprising detecting a possible location of a device that is not represented in the data structure and updating the data structure to include at least one device identifier.

11. The method according to claim 7 comprising displaying a map that comprises multiple symbols that represent the possible locations of the multiple devices and rotating the map in response to the user provided location information.

12. A computer program product comprising a computer usable medium including a computer readable program, wherein the computer readable program when executed on a computer of a first device causes the computer to:
estimate locations of a second device and a third device in response to a strength indication signal and in response to a strength of a signal that was transmitted from the second device and was received by the first device;
wherein the strength indication signal was received by the first device after being transmitted by the second device and over a short range communication channel;
wherein the strength indication signal is representative of a strength of a signal that was transmitted by the third device and was received by the second device; and
provide to a user of the first device location information representative of the locations of the second device and of the third device.

13. The computer program product according to claim 12 that causes the computer to provide a map that comprises a second symbol that represent an estimated location of the second device and an third symbol that represents an estimated location of the third device; wherein the map is rotatable along its axis.

14. The computer program product according to claim 12 that causes the computer to provide a map that comprises a second symbol that represent an estimated location of the second device, an third symbol that represents an estimated location of the third device, a second device identifier and a third device identifier; wherein the second device identifier and the third device identifier are defined by the user of the first device.

15. The computer program product according to claim 12 that causes the computer to provide a map that comprises multiple third symbols that represent possible locations of the third device.

16. The computer program product according to claim 12 that causes the computer to:
receive from a user of the first device a request to communicate with the second device via a non-short range communication channel; and
initiate a communication via the other communication channel.

17. The computer program product according to claim 16 that causes the computer to provide initiate the communication via the other communication channel by sending a communication controller a short range communication identifier of the second device.

18. A computer program product comprising a computer usable medium including a computer readable program, wherein the computer readable program when executed on a computer of a first device causes the computer to:
detect possible locations of multiple devices in response to strength of signals transmitted by the multiple devices;
display, by a first device, location information representative of possible locations of the multiple devices and displaying aliases assigned to the multiple devices by a user of the first device;
receive user provided location information representative of a location of a certain device out of the multiple devices;
update location information relating to at least the certain device in response to the user provided location information;
receive a request from a user to communicate with another device out of the multiple devices; and
initiate a communication with the other device.

19. The computer program product according to claim 18 that causes the computer to rotate at least one symbol representative of a possible location of a device out of the multiple devices in response to the user provided location information.

20. The computer program product according to claim 18 that causes the computer to maintain a data structure that maps between devices identifiers allocated by a user of the first device and devices identifiers that were allocated by other entities.

21. The computer program product according to claim 18 that causes the computer to detect a possible location of a device that is not represented in the data structure and updating the data structure to include at least one device identifier.

22. The computer program product according to claim 18 that causes the computer to display a map that comprises multiple symbols that represent the possible locations of the multiple devices and rotating the map in response to the user provided location information.

23. A mobile device comprising:
a transceiver, adapted to exchange signals over a short range communication channel;
a location detector, adapted to detect possible locations of multiple devices in response to strength of signals transmitted by the multiple devices; and
a user interface, adapted to:
display location information representative of possible locations of the multiple devices and displaying aliases assigned to the multiple devices by a user of the mobile device;
receive user provided location information representative of a location of a certain device out of the multiple devices;
wherein the location detector is further adapted to update location information relating to at least the certain device in response to the user provided location information;
wherein the user interface is further adapted to receive a request from a user to communicate with another device out of the multiple devices; and
wherein the transceiver initiates a communication with the other device.

24. The device according to claim 23 adapted to rotate at least one symbol representative of a possible location of a device out of the multiple devices in response to the user provided location information.

25. The device according to claim 23 wherein the transceiver is adapted to receive a strength indication signal that is transmitted from a second device; wherein the strength indication signal is representative of a strength of a signal that was transmitted by a third device and was received by the second device; and
wherein the location detector is adapted to estimate locations of the second device and the third device in response to a content of the strength indication signal and in response to a strength of a signal that is received by the mobile device and was transmitted by the second device.
